(19) United States
(12) Patent Application Publication
(10) Pub. No.: US 2015/0122231 A1
(43) Pub. Date: May 7, 2015

(54) METHOD TO DISPERSE LUBRICATION INTO A FUEL SUPPLY FOR A FUEL GAS SYSTEM

(71) Applicant: Caterpillar Motoren GmbH & Co. KG, Kiel (DE)

(72) Inventor: Thorsten Tüxen, Gettorf (DE)

(73) Assignee: Caterpillar Motoren GmbH & Co. KG, Kiel (DE)

(21) Appl. No.: 14/594,209

(22) Filed: Jan. 12, 2015

(51) Int. Cl. F02M 25/06; F02B 45/00; F02M 21/02

(52) U.S. Cl. CPC F02M 25/06; F02M 21/0293; F02B 45/00
USPC 123/527

(57) ABSTRACT

A method to deliver natural gas (NG) to an internal combustion engine (ICE) via an fuel gas intake assembly is disclosed. The fuel gas intake assembly includes a gas intake manifold and at least one gas admission valve (GAV). The ICE is in fluid communication with the GAV. The method includes the provision of at least one lubrication introduction device, at least a portion of which is laden with a lubricant. The at least one lubrication introduction device is positioned downstream from the gas intake manifold and upstream from the GAV. A substantially pressurized NG is introduced into the gas intake manifold, which causes passage of the NG through the lubrication introduction device. This causes the NG to entrain lubricant from the lubrication introduction device, introduce the lubricant into the fuel gas intake assembly, and deposit the lubricant, at least partially, into the GAV.

### TECHNICAL FIELD

The present disclosure relates generally to a method to deliver fuel gas in internal combustion engines. More specifically, the present disclosure relates to a system to introduce lubrication into fuel gas to reduce wear of fuel inlet valves during delivery of fuel gas.

### BACKGROUND

A dual fuel internal combustion engine (ICE) can typically operate in a liquid fuel mode (LFM) and in a gaseous fuel mode (GFM). In LFM, a liquid fuel, such as diesel, is injected directly into an engine cylinder or a pre-combustion chamber as the sole source of energy during combustion. In GFM, a gaseous fuel, such as natural gas (NG), is generally mixed with air in an intake port of a cylinder and a small amount of liquid fuel is injected into the cylinder in order to ignite the mixture of air and gaseous fuel. In such dual fuel internal combustion engines, one or more of such gas admission valves (GAV) are positioned between a source of gaseous fuel and an air intake of the engine. When a GAV is opened in GFM, the gaseous fuel passes into the air intake for mixing with the air.

GAVs are usually plate valves with a metallic sealing surface. These valves are generally prone to attract an abundance of particles. Given an NG fuel source, such valves face increased plate wear and degradation. Specialized coatings may be applied to solve such degradation issues. However, such specialized coatings are relatively expensive.

GAVs may be solenoid operated. Typically, such valves include a movable plate and a stationary plate or disc. During operation in LFM, the movable plate may dither on the stationary plate (or disc) of a closed GAV. Therefore, both the movable plate and stationary plate may be susceptible to increased wear. Additionally, a clearance that exists between the movable plate and the stationary plate may unduly trap small constituents flowing therethrough. This generally is an additional cause of wear.

Accordingly, the system and method of the present disclosure solves one or more problems set forth above and/or other problems in the art.

### SUMMARY OF THE INVENTION

Various aspects of the present disclosure illustrate a method to deliver natural gas (NG) to an internal combustion engine (ICE), via a fuel gas intake assembly. The fuel gas intake assembly includes a gas intake manifold and at least one gas admission valve. The ICE is in fluid communication with the gas intake manifold and the at least one gas admission valve. The method includes the provision of at least one lubrication introduction device, with at least a portion of the at least one lubrication introduction device laden with a lubricant. This is to provide a source of lubrication within the fuel gas intake assembly. At least one lubrication introduction device is positioned downstream from the gas intake manifold and upstream from the at least one gas admission valve. Thereafter, a substantially pressurized NG is introduced into the gas intake manifold, which causes a passage of the NG through the lubrication introduction device. This in turn causes the NG to entrain lubricant from the lubrication introduction device. This facilitates further introduction of the lubricant into the fuel gas intake assembly and a deposit of the lubricant entrained by the NG, at least partially, into the at least one gas admission valve, during a delivery of the NG to the ICE.

Another aspect of the present disclosure illustrates an internal combustion engine (ICE), which comprises a fuel gas intake assembly for a delivery of NG into the ICE. The fuel gas intake assembly includes a gas intake manifold. The gas intake manifold is in fluid communication with the ICE and is configured to introduce NG into the ICE. An inlet valve is configured to regulate a flow of NG into the ICE. Further, a filter assembly is positioned between the gas intake manifold disposed on the engine and the inlet valve. The filter assembly is structured and arranged to receive substantially all of the NG. More particularly, the filter assembly includes an element structured and arranged to retain lubricant thereon. Additionally, the NG is in fluid communication with the inlet valve through the lubricant disposed in the filter assembly.

### BRIEF DESCRIPTION OF THE DRAWINGS

FIG. 1 is a schematic of an exemplary engine layout that employs an natural gas (NG) intake assembly (or fuel gas intake assembly) with natural gas (NG) as a fuel, in accordance with the concepts of the present disclosure;

FIG. 2 is a schematic layout of a gas valve unit employed with the exemplary engine layout of FIG. 1, in accordance to the concepts of the present disclosure;

FIG. 3 illustrates a filter assembly of the gas valve unit of FIG. 2, in accordance with the concepts of the present disclosure; and

FIG. 4 is a flowchart that depicts an exemplary methodology of the fuel gas intake assembly, in accordance with the concepts of the present disclosure.

### DETAILED DESCRIPTION

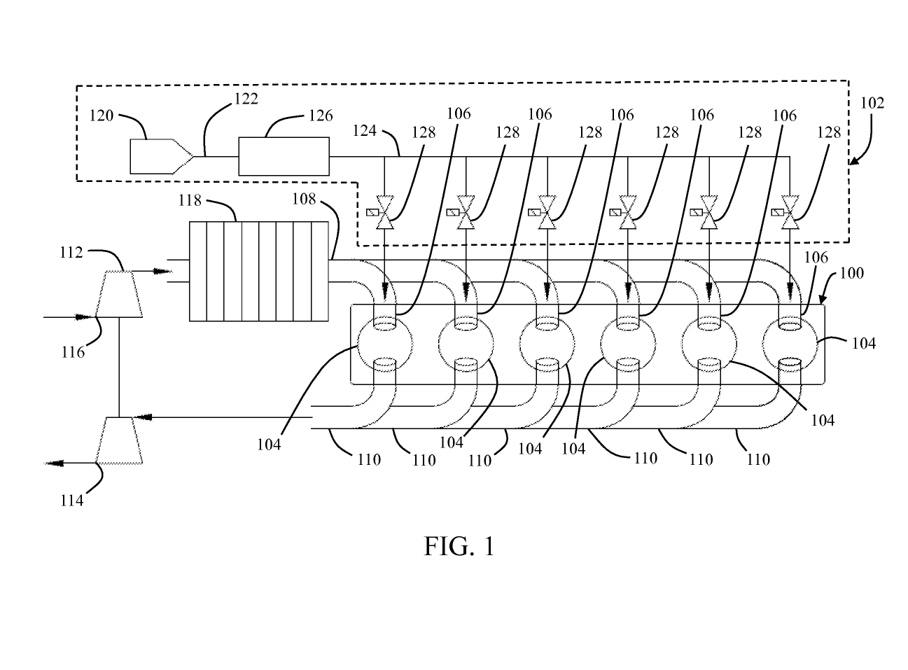

Referring to FIG. 1, an engine 100 includes a Natural Gas (NG) intake assembly (also referred to as fuel gas intake assembly 102). The engine 100 may be a dual-fuel engine with selective usages of gasoline, diesel and/or other fuel. The engine 100 may be an internal combustion engine (ICE), and accordingly, references to the engine 100 may be used interchangeably with ICE 100. Usage of the ICE 100 may be envisioned in construction machines, power plants, marine applications, locomotives, and other known applications involving NG. Moreover, engine 100 may also be used to power generators in electrical power generation applications. According to the principle laid out, concepts of the present disclosure may be associated with applications in mining, agriculture, forestry, construction, and/or other common industrial use, as well. As an example, off-highway trucks, scrapers, motor graders, large mining trucks (LMTs), articulated trucks, asphalt pavers, and tracked machines to name some applications. However, this list may not be exhaustive.

The engine 100 includes six cylinders 104, however more or fewer cylinders are also contemplated by the present disclosure. Air-Fuel mixture intake ports 106 (referred to as fuel intake ports 106 for convenience) and combustion exhaust ports 110 may be configured as conventionally known, to facilitate air-fuel mixture intake and exhaust for the associated combustion procedures and operations of the engine 100, respectively. Fuel intake ports 106 may communicate with an air intake zone 108 to receive air from a charge-air cooler 118.

As shown in FIG. 1, a turbocharger 112 is in fluid communication with the combustion exhaust port 110 to cause rotation of the turbine therein to increase the air-fuel density being introduced at the fuel intake ports 106 as is customary. Specifically, a compressor portion of the turbocharger 112 is mechanically coupled to a turbine portion of the turbocharger 112 and pumps compressed air into the fuel intake port 106 via a conveniently positioned fluid inlet 116. A fluid outlet 114 of the turbocharger 112 may facilitate exhaust of gases that result from engine operation.

The charge-air cooler 118 may be positioned to receive the compressed air prior to the fuel intake ports 106. The charge-air cooler 118 may be an intercooler, which may be an air-to-air or an air-to-liquid heat exchange device, which is designed to improve volumetric efficiency of the engine 100 by increasing intake air-charge density through isochoric cooling.

The NG intake assembly (or fuel gas intake assembly 102) includes a fuel gas inlet 120 that supplies fuel gas (or NG) to the engine 100. This fuel gas may be stored as Liquefied Natural Gas (LNG) upstream of the ICE 100, which is suitably regasified into gaseous phase. A gas intake manifold 122 is configured to receive the NG and transport the NG to the engine 100, via gas fluid lines 124. A gas valve unit 126 is positioned to introduce a flow of fuel gas into the gas fluid lines 124 of the engine 100. Gas admission valves (GAVs) 128 are configured to regulate flow of gas introduced by the gas valve unit 126 into the engine 100. Details of the GAVs 128 will be discussed below.

The GAVs 128 may be plate valves with metallic sealing surfaces. GAVs 128 are structured en route to each of the cylinders 104, via the gas fluid lines 124. As gas fluid lines 124 bifurcate on an approach to each of the respective cylinders 104, as shown, and given the six-cylinder configuration in the depicted embodiment, six corresponding GAVs 128 may be suitably deployed. Each GAV 128 may be disposed on each of the bifurcated gas fluid lines 124. However, the number of GAVs 128 may vary. For example, two or more GAV 128 may cater fuel regulation for one of the cylinders 104. The engine 100 is thus in fluid communication with the gas intake manifold 122 via the GAV 128, and thus, facilitates introduction of NG into the ICE 100. Components such as plates of the GAVs 128 may include one or more coatings of anti-corrosive resistive materials. Further variations of the GAV 128 may be contemplated, and thus the arrangement shown and/or disclosed here need not be seen as being limiting in any way.

In the disclosed embodiment, the GAVs 128 are generally inlet valves that are normally-closed (NC) inlet valves, in which one or more resilient members (such as a spring) may hold a lower movable disk (not shown) against an upper stationary disk (not shown). A mate between the lower movable disk and the upper stationary disk is configured to provide a seal that facilitates regulation of the fuel gas flow. The lower moveable disk may move relative to the upper stationery disk by means of a solenoid-operated arrangement. Therefore, when an actuating current is suitably delivered, the lower movable disk is pulled upward. In so doing, the lower movable disk may move out of sealed engagement with the upper stationary disk, allowing gaseous fuel to flow from gas intake manifold 122. Subsequently, the gaseous fuel may flow out of an outlet for delivery into the cylinders 104. Conversely, the lower plate may be stationary and the upper plate may be movable. Further, a variety of other GAV configurations may be envisioned. The GAVs 128 may be positioned within an engine head of the engine 100. Other type of GAVs may also be contemplated.

Effectively, the GAVs 128 are fluidly connected to the fuel gas inlet 120, via the gas fluid lines 124, which in turn is connected to a source of gaseous fuel, such a fuel tank. In this manner, a fuel delivery to the cylinders 104 is connected and regulated. In an embodiment, an electronic control module (ECM) may electronically control operations of the GAV 128. Although not shown, such a gaseous fuel system might typically include a balance regulator positioned between the source of gaseous fuel, such as a fuel tank (not shown), and the fuel intake ports 106. Further, a nozzle portion (not shown) of the GAV 128 may be positioned within the fuel intake port 106 of cylinder 104, to enable mixing and atomization of the incoming gaseous fuel with intake air from the turbocharger 112.

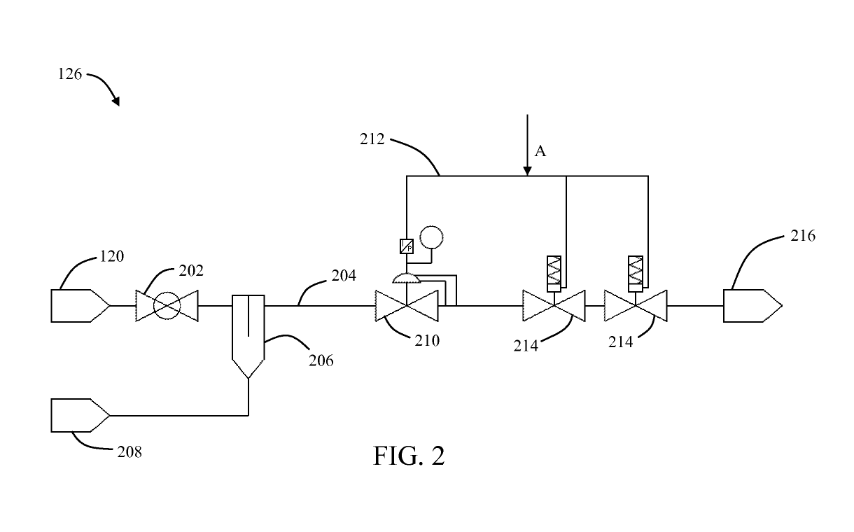

Referring to FIG. 2, a detailed schematic of the gas valve unit 126 is shown. The gas valve unit 126 includes a ball valve 202. The ball valve 202 may be at least one among the automatically operable valves configured to introduce NG into NG lines 204. A lubrication introduction device 206 is positioned downstream from an NG flow device, such as the fuel gas inlet 120 and upstream from the at least one gas admission valve. The lubrication introduction device 206 may be mounted on a gas-regulating unit (not shown), although other locations are possible. The lubrication introduction device 206 facilitates introduction of a lubricant into the NG lines 204. More particularly, the lubrication introduction device 206 may be a filter assembly, which is laden with a suitable well-known lubricant. Accordingly, the lubrication introduction device 206 is interchangeably referred to as the filter assembly 206, hereinafter. Additionally, the filter assembly 206 is positioned between the fuel gas inlet 120 disposed on the engine 100 (see FIG. 1) and the GAV 128 (see FIG. 1), and is structured and arranged to receive substantially all of the fuel gas (NG).

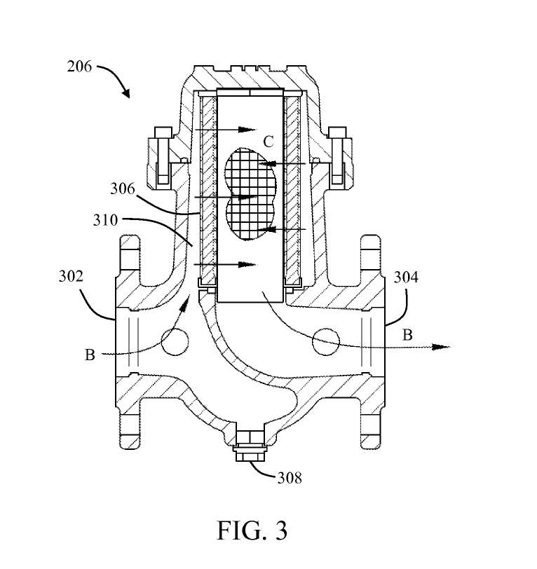

In an embodiment, a lubricant inlet 208 is configured to introduce lubricant to the filter assembly 206 at a potential relative to the pressure maintained within the NG lines 204. This potential may help maintain the lubrication at a particular level of pressure (and/or volume) within the filter assembly 206. In the preferred embodiment, the filter assembly 206 includes an element, such as a filter cartridge 306 (see FIG. 3), structured and arranged to retain the lubricant thereon. The NG is in fluid communication with the GAV 128 through the lubricant disposed in the filter assembly 206. In another embodiment, a lubricant may be introduced into the gas flow by greasing the filter assembly 206 during service and maintenance, or other operations that involve a disassembly of the associated components. Various other methods of introducing lubricants may be envisioned. Moreover, devices other than the filter assembly 206 may be contemplated as well.

A pressure regulator 210 is suitably positioned further downstream to the filter assembly 206, which is configured to regulate a pressurized flow of NG. The pressure regulator 210 may be pneumatically operated, although other operable means may be contemplated.

Further, a pair of serially connected pneumatic valves 214 is positioned downstream from the pressure regulator 210. The pneumatic valves 214 further interact with the NG flow to shut down or enable fuel gas delivery to the engine 100. Each of the pneumatic valves 214 may be independently connected to the NG lines 204 and may be independently operable. The pneumatic valves 214 may be fluidly connected to pneumatic lines 212 through which a controlled delivery of air is facilitated along direction, A, in turn enabling switchable configurations of the pneumatic valves 214. In an embodiment, each of the pneumatic valves 214 may vary between completely closed, or a completely open configuration. A fuel gas outlet 216 is provided for an associated exit.

Referring to FIG. 3, the filter assembly 206 is shown in greater detail. The filter assembly 206 includes a filter inlet 302, a filter outlet 304, a filter cartridge 306, and a particle relief port 308.

The filter cartridge 306 may facilitate segregation of the NG flow from flow contaminants and debris that dilutes an NG flow, and which affect operational efficiency of the engine 100. The filter inlet 302 receives a pressurized NG flow (direction, B), and thereafter, a diversion chamber 310 within the filter assembly 206 diverts the said flow towards the filter cartridge 306. The NG flow passes through the filter cartridge 306 and thus, a filtered NG flow enters (in direction, C) into a region disposed within the filter cartridge 306. As the filter cartridge 306 is substantially lubricant laden, the NG flow through the filter cartridge 306 facilitates entrainment of the lubricant. The filtered (and the lubricant entrained) NG then flows out of the filter assembly 206 from the filter outlet 304 in the direction, B. Further, the particle relief port 308 may include a screw device (not shown) that facilitates removal of contaminants from the NG flow. As an example, a magnetic device (not shown) may be positioned suitably to attract, accumulate, and collect, metallic debris from the NG flow.

Although not explicitly shown, one or more filter assemblies (such as the filter assembly 206), within the exemplary fuel gas intake assembly 102, may be equipped with lubrication supply. Other components, via which an exemplary NG flow would pass through, may suitably hold an entrainable lubricant, as well.

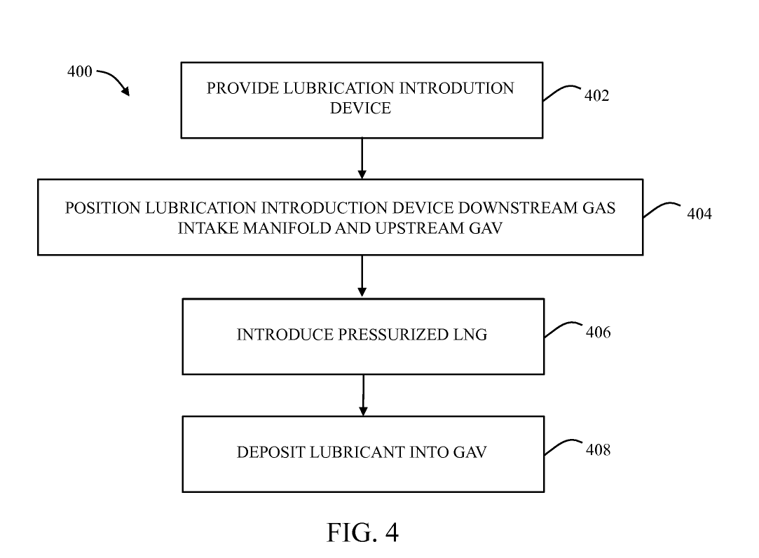

Referring to FIG. 4, an exemplary method applied to the fuel gas intake assembly 102 is depicted and discussed by means of a flowchart 400. The method is discussed in conjunction with FIGS. 1, 2, and 3.

The method to deliver NG initiates at step 402. At step 402, the lubrication introduction device 206 is provided. The lubrication introduction device 206 includes at least a portion laden with a lubricant. This arrangement is configured to provide a source of lubrication to the GAVs 128. The method proceeds to step 404.

At step 404, the filter assembly 206 is positioned downstream from the gas intake manifold 122 and upstream from the GAVs 128. The method proceeds to step 406.

At step 406, a substantially pressurized NG is introduced into the gas intake manifold 122, which causes a passage of the NG through the lubrication introduction device 206. As a result, the NG flow entrains lubricant from the lubrication introduction device 206 and thus introduces the lubricant into the NG fuel gas intake assembly 102. The method proceeds to end step 408.

At end step 408, the lubricant entrained by the NG is at least partially deposited into the GAVs 128. More particularly, the delivery of the lubricant is facilitated onto the upper and the lower plates (not shown) of the GAVs 128. Thereafter a delivery of the NG may be facilitated to the engine 100.

### INDUSTRIAL APPLICABILITY

During operation, a pressurized flow of NG enters the gas intake manifold 122. The pressurized flow may then enter into the NG Lines 204 of the gas valve unit 126. As lubricant is maintained with the filter cartridge 306, a pressurized NG flow through the filter cartridge 306 entrains the maintained lubricant at least partially into the NG flow. Thereafter, a substantial forceful introduction of a lubricant-laden NG flow is facilitated into the NG lines 204. As the lubricant-laden NG flows across the gas valve unit 126, it passes through the pressure regulator 210, the pneumatic valves 214, and exits at the fuel gas outlet 216. As a result, this pressurized flow enters the gas fluid lines 124, facilitating introduction of the lubricant substantially forcefully into a re-gasified flow (or a NG gas stream), within the gas fluid lines 124. Subsequently, the lubricant-laden NG flow enters the GAVs 128, where the NG flow deposits the lubricant at least partially onto the upper and the lower plates (not shown) of the GAVs 128. This deposition of lubricant allows the plates to be relatively less prone to friction and/or corrosion. Therefore, the GAVs 128 are sufficiently prevented from degradation, and the life of the components of the GAVs 128 is prolonged.

A general reason why GAVs involved in fuel gas operations with LNG storage systems are subject to a relatively faster degradation rate, compared to compressed natural gas (CNG) storage/supply systems, is the absence of a lubricant. This inadequacy is addressed in the flow of operations described above. Moreover, concepts of the present disclosure may be suitably applied in environments that are similar to what has been described so far.

Optionally, as more lubricant is entrained into a continuously pressurized NG flow, further lubrication may be required. This may require an application involving the delivery of additional lubricant to the filter assembly 206, at a predetermined potential. In so doing, a minimum amount of lubricant may be maintained by the filter cartridge 306 at substantially all times. Therefore, situations where lubrication lessens in volume over the GAV plates may be avoided. In effect, a minimum potential maintained within the filter cartridge 306 may facilitate sufficient delivery of additional (or available) lubricant to the GAVs 128.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method of delivering natural gas (NG) to an internal combustion engine (ICE) via an fuel gas intake assembly, the fuel gas intake assembly including a gas intake manifold and at least one gas admission valve, the ICE being in fluid communication with the gas intake manifold and the at least one gas admission valve, the method comprising:
providing at least one lubrication introduction device, and having at least a portion of the at least one lubrication introduction device laden with a lubricant to provide a source of lubrication thereof;
positioning the at least one lubrication introduction device downstream the gas intake manifold and upstream the at least one gas admission valve;
introducing a substantially pressurized NG into the gas intake manifold, thereby causing a passage of the NG through the at least one lubrication introduction device, in turn causing the NG to entrain the lubricant from the at least one lubrication introduction device and introduce the lubricant into the fuel gas intake assembly; and
depositing the lubricant entrained by the NG at least partially into the at least one gas admission valve during a delivery of the NG to the ICE.

2. An internal combustion engine (ICE), comprising
a fuel gas intake assembly for a delivery of natural gas (NG) into the internal combustion engine (ICE), the fuel gas intake assembly including:
a gas intake manifold in fluid communication with the ICE and configured to introduce NG into the ICE;
an inlet valve configured to regulate a flow of NG into the ICE; and
a filter assembly structured and arranged to receive substantially all of the NG and the filter assembly being positioned between the gas intake manifold disposed on the ICE and the inlet valve, the filter assembly including an element therein and the element being structured and arranged to retain lubricant thereon, the NG being in fluid communication with the inlet valve through the lubricant disposed in the filter assembly.
